(19) United States
(12) Patent Application Publication
(10) Pub. No.: US 2024/0074345 A1
(43) Pub. Date: Mar. 7, 2024

(54) SYSTEM AND METHOD FOR ENSURING SEED QUALITY AT PLANTING USING TERAHERTZ SIGNALS

(71) Applicant: Deere & Company, Moline, IL (US)

(72) Inventors: Mahesh SOMAROWTHU, Pune (IN); Noel W. ANDERSON, Fargo, ND (US); Gurmukh H. ADVANI, West Fargo, ND (US)

(21) Appl. No.: 17/903,231

(22) Filed: Sep. 6, 2022

(51) Int. Cl. A01C 1/02; G01N 21/3581

(52) U.S. Cl. CPC A01C 1/025; G01N 21/3581

(57) ABSTRACT

An agricultural machine includes a seeding system having a seed transport mechanism configured to transport a seed along a transport route. A terahertz-based seed sensor is configured to direct terahertz electromagnetic radiation toward the seed at a sensing location along the transport route and detect terahertz electromagnetic radiation after the terahertz electromagnetic radiation interacts with the seed to provide terahertz data. An actuator is configured to selectively move the seed. A processing system is configured to receive the terahertz data and classify the seed as qualified or non-qualified and to selectively engage the actuator based on whether the seed is classified as qualified or non-qualified.

### FIELD OF THE DESCRIPTION

The present description generally relates to planting equipment. More specifically, but not by limitation, the present description relates to a processing and control system for an agricultural planting machine that is configured to sense seed quality in a seeding system and to control seed release to a target location.

### BACKGROUND

There are a wide variety of different types of agricultural seeding or planting machines. They can include row crop planters, grain drills, air seeders or the like. These machines place seeds at a desired depth within a plurality of parallel seed trenches that are formed in the soil. Thus, these machines can carry one or more seed hoppers. The mechanisms that are used for moving the seed from the seed hopper to the ground often include a seed metering system and a seed delivery system.

During a planting operation, it is useful to determine if a seed is viable to ensure that only viable seeds are planted thereby increasing yields and efficiency. In some known systems, sensors may be used to detect seed quality in a lab setting or at a seed provider to avoid planting inferior or damaged seed. However, damage to seed may occur during storage of the seed or after delivery from the lab or seed provider. During planting operations of a planter, the real-time detection and rejection of damaged or inferior seed on a planter can present timing and other technical problems. Further, techniques that simply view or sense an exterior of a seed may not detect issues within the seed during plating. Thus, there is a need for an improved system and method for detecting seed viability with a planter or row planting unit.

The discussion above is merely provided for general background information and is not intended to be used as an aid in determining the scope of the claimed subject matter.

### SUMMARY

An agricultural machine includes a seeding system having a seed transport mechanism configured to transport a seed along a transport route. A terahertz-based seed sensor is configured to direct terahertz electromagnetic radiation toward the seed at a sensing location along the transport route and detect terahertz electromagnetic radiation after the terahertz electromagnetic radiation interacts with the seed to provide terahertz data. An actuator is configured to selectively move the seed. A processing system is configured to receive the terahertz data and classify the seed as qualified or non-qualified and to selectively engage the actuator based on whether the seed is classified as qualified or non-qualified.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 shows one example of a top view of an agricultural machine.

FIG. 2 shows one example of a side view of a row unit of the agricultural machine shown in FIG. 1.

FIG. 3 is a perspective view of a portion of a seed metering system.

FIGS. 3A and 3B show two examples of different seed delivery systems that can be used with a seed metering system.

FIG. 4 is a simplified block diagram of one example of an agricultural machine architecture.

FIG. 5 is a diagrammatic view of a terahertz-based sensor in accordance with one embodiment.

FIG. 6 is a flow diagram of one example operation of an agricultural machine.

FIG. 7 is a block diagram showing one example of the architecture illustrated in FIG. 4, deployed in a remote server architecture.

FIG. 8 is a diagrammatic view of an example mobile device that can be used in the architectures shown in the previous figures.

FIG. 9 is a block diagram showing one example of a computing environment that can be used in the architectures shown in the previous figures.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, instruments system, methods, and any further application of the principles of the present disclosure are fully contemplated as would normally occur to one skilled in the art to which the disclosure relates. In particular, it is fully contemplated that the features, components, steps, or a combination thereof described with respect to one example may be combined with the features, components, steps, or a combination thereof described with respect to other examples of the present disclosure.

The International Telecommunications Union (ITU) defines terahertz electromagnetic radiation as having a frequency between 0.3 and 3.0 terahertz. Other sources define the band to include frequencies as low as 0.1 terahertz and as high as 30 terahertz. As used herein, the band includes frequencies from 0.1 terahertz to 30 terahertz. As used herein, this band includes frequencies from 0.1 terahertz to 30 terahertz. Terahertz electromagnetic radiation is subject to significant laboratory research and shows promise for agricultural applications. It lies between microwave and infrared on the electromagnetic spectrum and provides the advantage of at least partial penetration into objects, but is not considered ionizing radiation, like X-rays. As such, terahertz radiation does not trigger a requirement for a safety officer, nor is it subject to significant regulations, such as those that apply to X-rays. However, terahertz electromagnetic radiation does provide improved detection abilities over optical techniques, IR and UV. In accordance with embodiments described below, terahertz electromagnetic radiation is employed relative to the planting operation to reduce or eliminate the number of non-qualified seeds that are planted during the planting operation. Terahertz electromagnetic radiation is also used during the planting operation to detect seed viability, seed contamination from fungus and other pathogens, seed contamination from coatings and other chemicals, non-genetically modified organisms (GMO), and other characteristics.

The present description generally relates to planting equipment. An example agricultural planting machine includes a seeding system that meters seeds from a source and delivers the seeds to a furrow or trench formed in the ground. The metering system operates to control the rate at which seeds are metered into the delivery system, to achieve a desired planting rate and/or seed spacing.

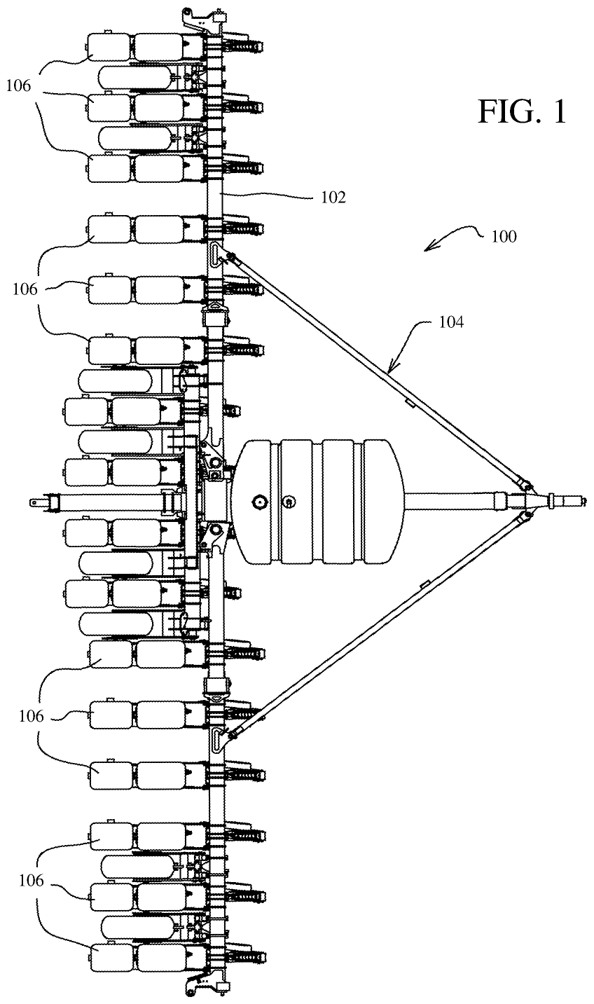

FIG. 1 is a top view of one example of an agricultural machine 100. Agricultural machine 100 illustratively includes a toolbar 102 that is part of a frame 104. FIG. 1 also shows that a plurality of row units 106 are mounted to the toolbar. Agricultural machine 100 can be towed behind another machine, such as a tractor.

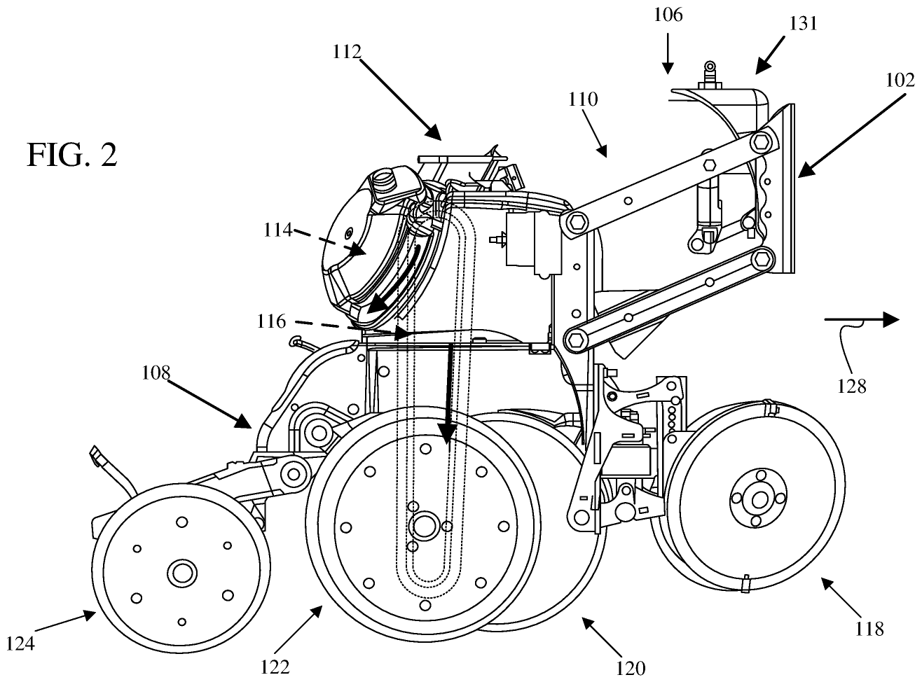

FIG. 2 is a side view showing one example of a row unit 106 in more detail. FIG. 2 shows that each row unit 106 illustratively has a frame 108. Frame 108 is illustratively connected to toolbar 102 by a linkage shown generally at 110. Linkage 110 is illustratively mounted to toolbar 102 so that it can move upwardly and downwardly (relative to toolbar 102).

Row unit 106 also illustratively has a seed hopper 112 that stores seed. The seed is provided from hopper 112 to a seed metering system 114 that meters the seed and provides the metered seed to a seed delivery system 116 that delivers the seed from the seed metering system 114 to the furrow or trench generated by the row unit. In one example, seed metering system 114 uses a rotatable member, such as a disc or concave-shaped rotating member, and an air pressure differential to retain seed on the disc and move it from a seed pool of seeds (provided from hopper 112) to the seed delivery system 116. Other types of meters can be used as well.

Row unit 106 can also include a row cleaner 118, a furrow opener 120, a set of gauge wheels 122, and a set of closing wheels 124. It can also include an additional hopper that can be used to provide additional material, such as a fertilizer or another chemical.

In operation, as row unit 106 moves in the direction generally indicated by arrow 128, row cleaner 118 generally cleans the row ahead of the opener 120 to remove plant debris from the previous growing season and the opener 120 opens a furrow in the soil. Gauge wheels 122 illustratively control a depth of the furrow, and seed is metered by seed metering system 114 and delivered to the furrow by seed delivery system 116. Closing wheels 124 close the trench over the seed. A downforce generator 131 can also be provided to controllably exert downforce to keep the row unit in desired engagement with the soil.

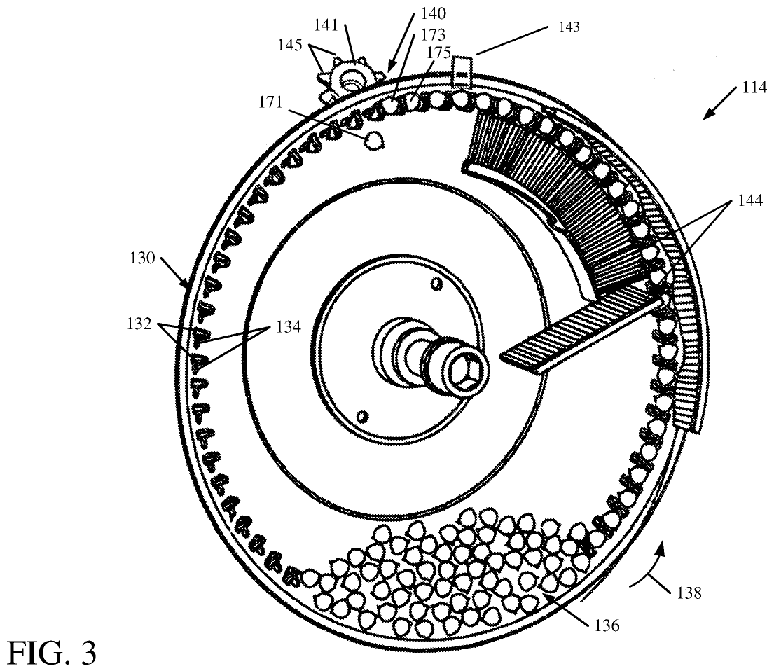

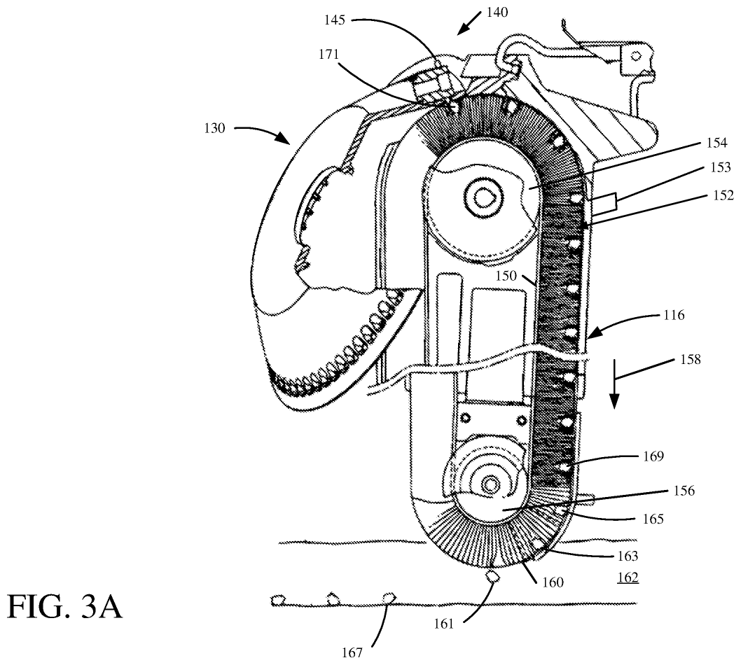

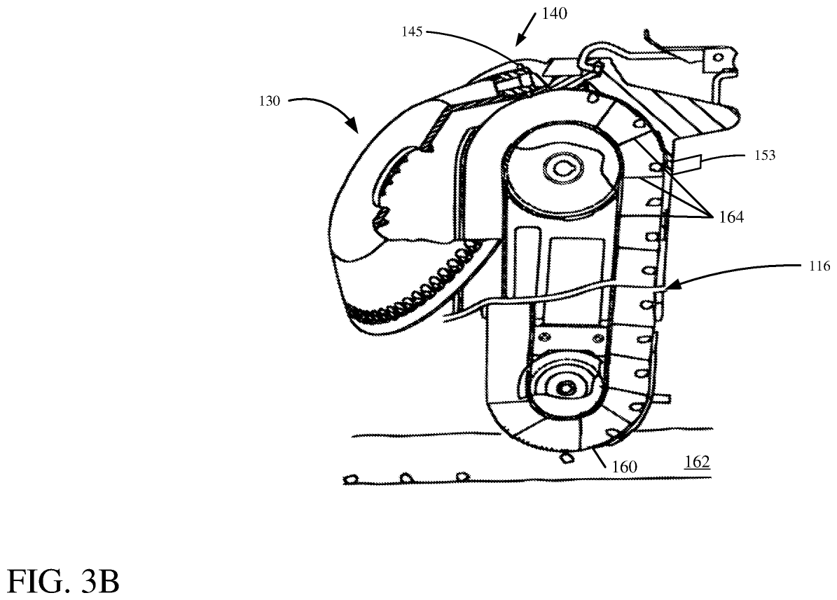

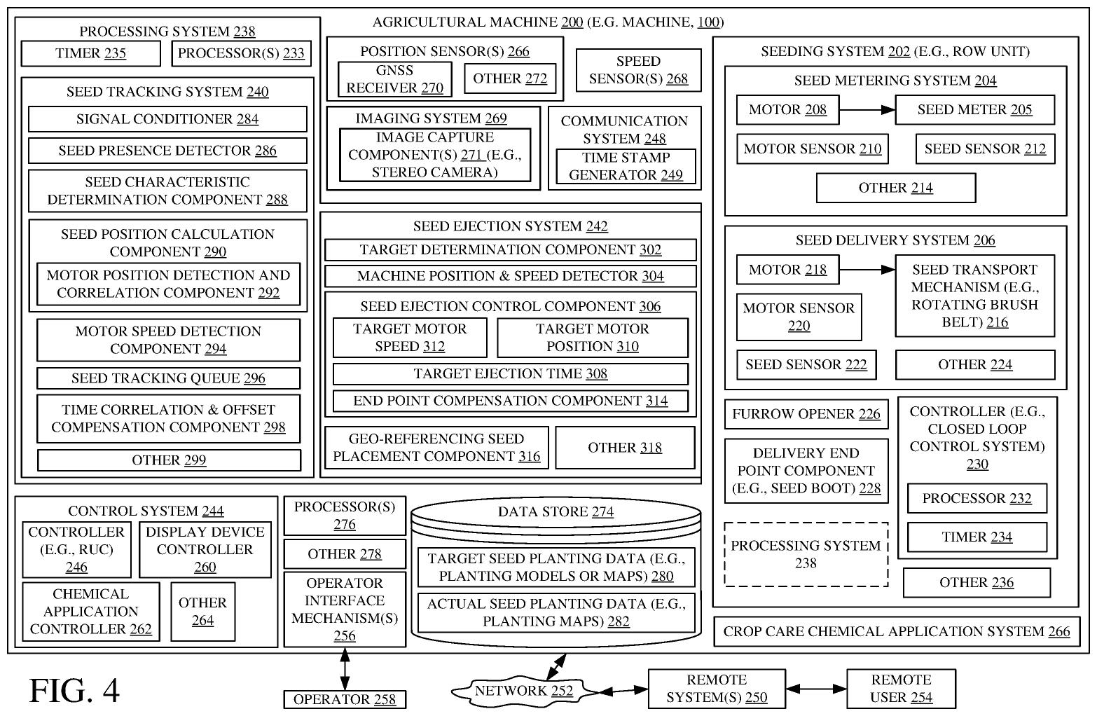

FIG. 3 shows one example of a rotatable mechanism that can be used as part of the seed metering system. The rotatable mechanism includes a rotatable disc, or concave element, 130. Rotatable element 130 has a cover (not shown) and is rotatably mounted relative to the frame 108 of the row unit 106. Rotatable element 130 is driven by a motor (shown in FIG. 4) and has a plurality of projections or tabs 132 that are closely proximate corresponding apertures 134. A seed pool 136 is disposed generally in a lower portion of an enclosure formed by rotating mechanism 130 and its corresponding cover. Mechanism 130 is rotatably driven by its machine (such as an electric motor, a pneumatic motor, a hydraulic motor, etc.) for rotation generally in the direction indicated by arrow 138, about a hub. A pressure differential is introduced into the interior of the metering mechanism so that the pressure differential influences seeds from seed pool 136 to be drawn to apertures 134. For instance, a vacuum can be applied to draw the seeds from seed pool 136 so that they come to rest in apertures 134, where the vacuum holds them in place. Alternatively, a positive pressure can be introduced into the interior of the metering mechanism to create a pressure differential across apertures 134 to perform the same function.

Once a seed comes to rest in (or proximate) an aperture 134, the vacuum or positive pressure differential acts to hold the seed within the aperture 134 such that the seed is carried upwardly generally in the direction indicated by arrow 138, from seed pool 136, to a seed discharge area 140. It may happen that multiple seeds are residing in an individual seed cell. In that case, a set of brushes or other members 144 that are located closely adjacent the rotating seed cells tend to remove the multiple seeds so that only a single seed is carried by each individual cell. Additionally, a sensor 143 is also illustratively mounted adjacent to rotating mechanism 130 as will be discussed in FIG. 4.

Once the seeds reach the seed discharge area 140, the vacuum or other pressure differential is illustratively removed, and a positive seed removal wheel, knock-out wheel 141, can act to remove the seed from the seed cell. Wheel 141 illustratively has a set of projections 145 that protrude at least partially into apertures 134 to actively dislodge the seed from those apertures. When the seed is dislodged, it is illustratively moved by the seed delivery system 116 (two examples of which are shown below in FIGS. 3A and 3B) to the furrow in the ground.

FIG. 3A shows an example where the rotating element 130 is positioned so that its seed discharge area 140 is above, and closely proximate, seed delivery system 116 which includes a seed transport mechanism. In the example shown in FIG. 3A, the seed transport mechanism includes a belt 150 with a brush that is formed of distally extending bristles 152 attached to belt 150. Belt 150 is mounted about pulleys 154 and 156. One of pulleys 154 and is illustratively a drive pulley while the other is illustratively an idler pulley. The drive pulley is illustratively rotatably driven by a conveyance motor (such as that shown in FIG. 4) which can be an electric motor, a pneumatic motor, a hydraulic motor, etc. Belt 150 is driven generally in the direction indicated by arrow 158.

Therefore, when seeds are moved by rotating element 130 to the seed discharge area 140, where they are discharged from the seed cells in rotating mechanism 130, they are illustratively positioned within the bristles (e.g., in a receiver) 152 by the projections 132 following each aperture that pushes the seed into the bristles. Seed delivery system 116 illustratively includes walls that form an enclosure around the bristles, so that, as the bristles move in the direction indicated by arrow 158, the seeds are carried along with them from the seed discharge area 140 of the metering mechanism, to a discharge area 160 either at ground level, or below ground level within a trench or furrow 162 that is generated by the furrow opener 120 on the row unit.

Additionally, a sensor 153 is also illustratively coupled to seed delivery system 116. As the seeds are moved within bristles 152, sensor 153 can detect the presence or absence of a seed as will be discussed below with respect to FIG. 4. It should also be noted that while the present description will proceed as having sensors 143 and 153, it is expressly contemplated that, in another example, only one sensor is used. Additional sensors can also be used.

FIG. 3B is similar to FIG. 3A, except that seed delivery system 116 is not formed by a belt with distally extending bristles. Instead, the transport mechanism includes a flighted belt in which a set of paddles 164 form individual chambers (or receivers), into which the seeds are dropped, from the seed discharge area 140 of the metering mechanism. The flighted belt moves the seeds from the seed discharge area 140 to the discharge area 160 within the trench or furrow 162.

There are a wide variety of other types of delivery systems as well, that include a transport mechanism and a receiver that receives a seed. For instance, they include dual belt delivery systems in which opposing belts receive, hold and move seeds to the furrow, a rotatable wheel that has sprockets which catch seeds from the metering system and move them to the furrow, multiple transport wheels that operate to transport the seed to the furrow, an auger, among others. The present description will proceed with respect to a brush belt, but many other delivery systems are contemplated herein as well.

The present description provides a processing and control system for an agricultural machine that is configured to sense and track individual seed movement through a seeding system and to control seed release to a target location.

FIG. 4 shows a block diagram of one example of an agricultural machine architecture including an agricultural machine 200 having a seeding system 202. One example of machine 200 includes machine 100 illustrated above with respect to FIG. 1. In this example, each row unit includes a seeding system 202 having a seed metering system 204 and a seed delivery system 206 disposed thereon or otherwise associated with the row unit.

Seed metering system 204 includes a seed meter 205 that is driven by a motor 208 to meter or otherwise singulate seeds from a seed source (such as a seed container or tank). One example of seed meter 205 is illustrated above with respect to FIG. 3.

Seed metering system 204 can include a motor sensor 210 configured to sense characteristics of motor 208, such as a speed and/or position of motor 208 (e.g., an angular position of a motor output shaft). A seed sensor 212 can also be provided that senses the presence of seeds in seed meter 205, and can include other items 214 as well.

Seed delivery system 206 includes a seed transport mechanism 216 driven by a motor 218. Examples of seed transport mechanism 216 are illustrated above with respect to FIGS. 3A and 3B.

A motor sensor 220, which can be integrated into motor 218, or provided separately (e.g., external to motor 218), is configured to sense operational characteristics of motor 218. For example, motor sensor 220 senses an angular position of an output shaft of motor 218, that is rotatably coupled to drive seed transport mechanism 216 to transport seeds, received from seed metering system 204, to a second or release position in which the seeds are released from the seed transport mechanism 216.

It is noted that while separate motors 208 and 218 are illustrated in FIG. 4, in another example only one motor can be used to drive both seed metering system 204 and seed delivery system 206.

A seed sensor 222 is positioned along the transport route to direct terahertz electromagnetic radiation at a seed to detect a characteristic of the seed. The detection and various characteristics will be described in greater detail below. One example of seed sensor 222 includes sensor 153 illustrated above in FIGS. 3A and 3B. Seed sensor 222 is configured to generate and send a sensor signal indicative of a characteristic of the sensed seed. As used herein, a sensor signal includes both analog signals and digital signals, such as communications using a controller area network (CAN) bus.

In addition to sending an indication (e.g., a sensor signal) indictive of the characteristic of the seed in the seed transport mechanism 216, seed sensor 222 (or another sensor) can be configured to sense other aspects of the seed as well, such as, but not limited to, a size, shape, color or other characteristic (such as an indication that the seed is cracked or otherwise irregular). Seed delivery system 206 can include other items 224 as well.

It is noted that while FIG. 4 illustrates seed sensors 212 and 222 in each of seed metering system 204 and seed delivery system 206, in one example only seed delivery system 206 includes a seed sensor (or at least system 204 does not include a seed sensor) configured to sense the characteristic of the seed as the seed passes the sensor location.

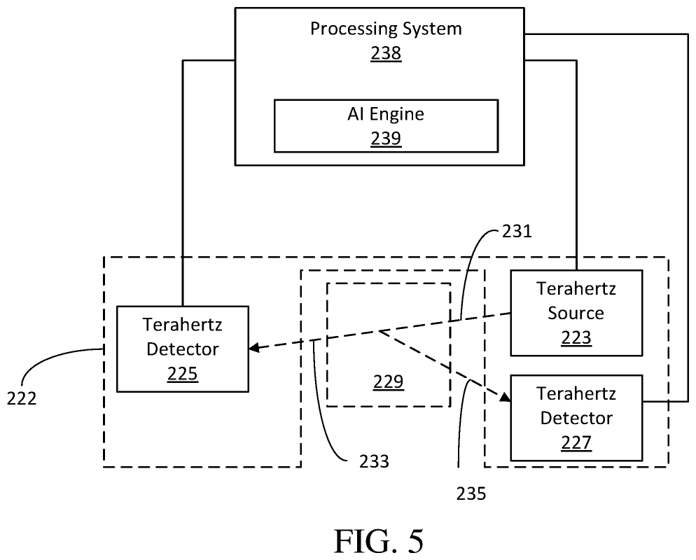

FIG. 5 is a diagrammatic view of a terahertz-based sensor in accordance with one embodiment. As shown in FIG. 5, terahertz-based sensor 222 includes terahertz source 223 and one or more terahertz detectors 225, 227. Source 223 is disposed to direct terahertz electromagnetic radiation 231 through a seed detection area 229 to one or more detectors 225, 227. In some examples, sensor 222 may only detect attenuation of terahertz electromagnetic radiation 231 after passing through seed area 229, in which case a single detector 225 may be used and positioned to receive the attenuated terahertz electromagnetic radiation 233. In other embodiments, sensor 222 may only detect reflection of the terahertz electromagnetic radiation 231 from a seed within seed detection area 229, in which case a single detector 227 may be used and positioned to receive the reflected terahertz electromagnetic radiation 235. Of course, embodiments also include using both such detectors 225, 227 to detect attenuated terahertz electromagnetic radiation 233 as well as reflected electromagnetic radiation 235. Further, those skilled in the art will appreciate that additional/alternate terahertz detectors can used to detect other types of interactions, such as backscatter. Terahertz source 223 and terahertz detectors 225, 227 may be configured to use a single frequency or in other examples, a plurality of frequencies.

Terahertz source 223 can be any suitable device capable of terahertz electromagnetic radiation to seed detection area 229. Examples, of such suitable devices include, without limitation, a femtosecond Ti-sapphire laser, a Yttrium Iron Garnet (YIG)-oscillator, a quantum cascade laser, a P-type germanium laser, a silicon-based laser; a free electron laser, a photoconductive switch, optical rectification, a backward-wave oscillator, a transferred electron device (i.e., Gunn diode), and a resonant tunneling diode. In embodiments where a number of frequencies within the terahertz range (0.1-30 terahertz) are desired, a variable frequency source can be used, such as a variable frequency quantum cascade laser. In other embodiments, a plurality of sources 223 can be used with each source 223 having a different band within the terahertz range. Additionally, it is expressly contemplated that source 223 may operate in a pulsed mode or a continuous wave mode.

Detectors 225, 227 can be any suitable device that can detect electromagnetic radiation in the terahertz range. Detectors 225, 227 may be configured to provide measurement in the frequency domain or the time domain to processing system 238. Examples of detectors 225, 227 include, without limitation, a photoconductive semiconductor, free-space electro-optic sampling using ZnTe and BBO crystals, bolometer, an interferometer, Schottkey diode, backward diode, High-Electron-Mobility-Transistor (HEMT), Golay cell, and a pyroelectric detector.

Terahertz sensor 222 provides a signal that contains significant information about the material that the terahertz electromagnetic radiation has passed through and/or reflected from. As shown in FIG. 5, the detector(s) 225, 227 are operably coupled to processing system 238, which may include or be coupled to artificial intelligence engine 239. Utilizing engine 239 allows processing system 238 to perform relatively high level classifications based on the received signal(s). Engine 239 may employ any suitable artificial intelligence and/or machine learning techniques in the provision of such classification. Examples of suitable artificial intelligence techniques include, without limitation, memory networks, Bayes systems, decisions trees, Eigenvectors, Eigenvalues and Machine Learning, Evolutionary and Genetic Algorithms, Expert Systems/Rules, Support Vector Machines, Engines/Symbolic Reasoning, Generative Adversarial Networks (GANs), Graph Analytics and ML, Linear Regression, Logistic Regression, LSTMs and Recurrent Neural Networks (RNNSs), Convolutional Neural Networks (CNNs), MCMC, Cluster Analysis, Random Forests, Reinforcement Learning or Reward-based machine learning. Learning may be supervised or unsupervised.

While a single sensor 222 is shown in FIG. 5 operably coupled to processing system 238, multiple such sensors can be used along the seed delivery path for each row unit. Generally, each row unit will include a single terahertz-based sensor located along a seed delivery path of the given row unit, where each sensor is coupled to processing system 238 such that AI engine 239 receives input from a plurality of terahertz-based sensors. Additionally, any additional sensors may be used to sense various aspects of the seeds and provide additional inputs to AI engine 239 for enhanced operation and classification. In some examples, these additional inputs include seed response to frequencies outside the terahertz range. Further, other types of sensors, such as one or more chemometric sensors may also be used as additional inputs to AI engine 239.

Returning to FIG. 4, seeding system 202 (e.g., on a particular row unit) can also include a furrow opener 226 configured to form a furrow or trench in the ground, a delivery endpoint component 228 configured to deliver the seed into the furrow, and a controller 230. In one example, controller 230 provides a closed loop control system and can include a processor 232 and a timer 234, which can be used to time the performance of operations within seeding system 102. Of course, seeding system 202 can include other items 236 as well.

As shown in FIG. 4, agricultural machine 200 includes processing system 238 having a seed tracking system 240 configured to track seed movement within seeding system 202 and a seed ejection system 242 configured to control, or to generate control signals that are used by a control system 244, to control ejection of the seeds from component 228. It is noted that while processing system 238 is broken out separately in FIG. 4, some or all of the tracking and ejection control functions can be performed by seeding system 202. The illustration in FIG. 4 is for sake of example only. Seed ejection system 242 may also be located with seed meter 114.

Before discussing processing system 238 in further detail, other components of machine 200 will be described. In the example illustrated in FIG. 4, control system 244 is configured to control other components and systems of machine 200. For instance, control system 244 generates control signals to control communication system 248 to communicate between components of machine 200 and/or with other systems, such as remote system 250 over a network 252. Network 252 can be any of a wide variety of different types of networks, such as the Internet, a cellular network, a local area network, a near field communication network, or any of a wide variety of other networks or combinations of networks or communication systems.

In the illustrated example, a remote user 254 is shown interacting with remote system 250. Remote system 250 can be a wide variety of different types of systems. For example, remote system 250 can be a remote server environment, remote computing system that may be used, for example, by a remote user 254. Further, it can be a remote computing system, such as a mobile device, remote network, or a wide variety of other remote systems. Remote system 250 can include one or more processors or servers, a data store, and it can include other items as well.

Communication system 248 can include wireless communication logic, which can be substantially any wireless communication system that can be used by the systems and components of machine 200 to communicate information to other items, such as between seeding system 202, processing system 238, and/or control system 244. In one example, communication system 248 communicates over a CAN bus (or another network, such as an Ethernet network, etc.) to communicate information between systems 202, 238, and/or 244. This information can include the various sensor signals and output signals generated based on the sensor variables and/or sensed variables.

Processing system 238 includes one or more processors 233. In one example, processor 233 implements a timer 235 utilized in conjunction with timer 234 of seed delivery system 206, to coordinate the sending and receiving of signals and messages between processing system 238 and seeding system 202. Also, the timers 234 and 235 can be utilized for the generation and application of control signals by control system 244 to seeding system 202, to control operation of seed delivery system 206 in transporting seeds to endpoint component 228. In one example, communication system 248 includes a timestamp generator 249, which is discussed in further detail below. Briefly, however, timestamp generator 249 is configured to generate timestamps, using timers 234 and 235, on messages and signals sent by systems 206 and 238. The timestamps can be utilized by the receiving system to determine a latency in the communication channel.

Control system 244 is configured to control interfaces, such as operator interface mechanisms 256 that include input mechanisms configured to receive input from an operator 258 and output mechanisms that render outputs to user 258. The user input mechanisms can include mechanisms such as hardware buttons, switches, joysticks, keyboards, etc., as well as virtual mechanisms or actuators such as a virtual keyboard or actuators displayed on a touch sensitive screen. The output mechanisms can include display screens, speakers, etc.

In the illustrated example, control system 244 includes a controller 246 configured to control seeding system 202 based on processing performed by processing system 238. This can include sending messages or other signals over any suitable communication mechanism, such as a CAN bus. Controller 246 can thus include a row unit controller (RUC) configured to control, either directly or with controller 230, the seeding system on each row unit.

It is noted that in one example seeding system 202 (e.g., on a particular row unit) includes some (or all) of the components and related functionality described with respect to processing system 238. This is represented by the dashed block in FIG. 4.

Control system 244 also is illustrated as including a display device controller 260 configured to control display device(s) that provide operator interface mechanisms 256, a chemical application controller 262, and can include other items 264 as well. Chemical application controller 262 is configured to control a crop care chemical application system 266 to control the application of chemicals, such as fertilizers, herbicides, pesticides, and the like. This is discussed in further detail below.

Machine 200 also includes a number of other sensors including, but not limited to, position sensor(s) 266 and speed sensor(s) 268. Position sensor(s) 266 are configured to determine a geographic position, heading, and/or route of machine 200. Position sensor 266 can include, but is not limited to, a Global Navigation Satellite System (GNSS) receiver 270 that receives signals from a GNSS satellite transmitter. Position sensor 266 can also include a Real-Time Kinematic (RTK) component that is configured to enhance the precision of position data derived from the GNSS signal from receiver 270. Illustratively, an RTK component uses measurements of the phase of the signal's carrier wave in addition to the information content of the signal to provide real-time corrections, which can provide up to centimeter-level accuracy of the position determination. Position sensor(s) 266 can include other items 272 as well.

Speed sensor(s) 268 are configured to determine a speed at which machine 200 is traversing a worksite (e.g., field or other terrain) during the planting operation. This can include sensors that sense the movement of ground engaging elements (e.g., wheels or tracks) and/or can utilize signals received from other sources, such as position sensor(s) 266.

Machine 200 also includes an imaging system 269 having image capture component(s) 271 configured to capture images and image processing component(s) configured to process those images. In one example, image capture component(s) 271 includes a stereo camera configured to capture video of the worksite being operated upon by machine 200. An example stereo camera captures high-definition video at thirty frames per second (FPS) with one hundred ten degree wide-angle field of view. Of course, this is for sake of example only. In one example, image capture components can include multi-spectral or hyper-spectral cameras. In any case, image capture component(s) 271 is configured to capture images of the terrain for processing by image processing component(s) 271. As discussed below, the images can be analyzed to determine planting locations, such as to avoid obstacles in the field, to conform to the field boundary, etc.

Machine 200 also includes a data store 274, one or more processors 276, and can include other items 278. Data store 274 can store any of a wide variety of different types of information. Illustratively, data store 274 stores target seed planting data (e.g., planning maps or other models) 280, actual seed planting data (e.g., planting maps) 282, and can store other data items as well.

Seed tracking system 240 illustratively includes a signal conditioner 284 configured to receive signals generated by sensor 222 (and/or sensor 212), and to condition those signals for subsequent processing. This can include amplifying the generated sensor signal, performing filtering, linearization, normalization and/or any other conditioning which can improve the quality of the sensor signal. The conditioned signal is then provided to other components of seed tracking system 240 such as, but not limited to, a seed presence detector 286, a seed characteristic determination component 288, and a seed position calculation component 290.

Seed characteristic determination component 288 is configured to detect a characteristic of the seed using signals from the terahertz-based sensor(s) 222 and/or artificial intelligence engine 239. For instance, component 288 can generate an output indicative of a seed viability, seed contamination from fungus and other pathogens, seed contamination from coatings and other chemicals, non-genetically modified organisms (GMO), as well as other characteristics such as size, shape, or color of the seed. This can be utilized to determine whether the detected seed is a qualified or non-qualified seed to determine in real-time or substantially real-time whether the individual seed should be planted.

Seed position calculation component 290 is configured to calculate the position of the seed in seed transport mechanism 216, thus facilitating tracking of movement of the seed through seed delivery system 206 as seed transport mechanism 216 (e.g., brush belt) is rotated by motor 218. Component 290 includes a motor position detection and correlation component 292 configured to detect the angular position of the output shaft of motor 218, which can be coupled directly, through a transmission component, or otherwise, to seed transport mechanism 216. In either case, component 292 correlates the position of the detected seed to the angular position of the output shaft of motor 218.

A motor speed detection component 292 detects the speed of motor 218, as it rotates to move seed transport mechanism 216 and convey the seed along the transport route. Seed tracking queue 296 stores tracking information for each seed whose presence is detected by detector 286. In one example, seed tracking queue 296 stores a plurality of data records or other data items that identify each seed individually, along with information that correlates the position of the seed to the position of mechanism 216 for position tracking of the individual seed. The information in seed tracking queue 296 can be utilized to identify a number of seeds that are presently in seed transport mechanism 216, as well as the spacings between each seed and a magnitude of rotation of the output shaft of motor 218 needed to move that seed to the release point, to release the seed toward endpoint component 228.

Depending on the type of communication channel utilized by communication system 248, latencies may be introduced in the communications. For example, a typical CAN message-based communication has latency delays on the order of 5 milliseconds. A time correlation and offset compensation component 298 is configured to correlate each message or other communication sent between processing system 238 and seeding system 202 using timestamps generated by the timestamp generator 249. Component 298 is configured to account for these latencies, by compensating for timing offsets. Examples of component 298 are discussed in further detail below.

Seed ejection system 242 includes a target determination component 302 configured to determine a target or target parameter for ejecting each seed from seed delivery system 206. The target can represent any of a variety of different types of input parameters. In the illustrated example, but not by limitation, the target is a target geographic location on the terrain (field). In one example, the target geographic location is referenced to an absolute location in the field, such as using global coordinates in a global coordinate system (e.g., World Geodetic System (WGS)). In one example, the target geographic location is referenced to local coordinates in the field.

Further, target locations for seed placement can be pre-defined (e.g., a target planting map). Alternatively, or in addition, target locations for seed placement are determined in situ or “on-the-fly”. For example, image system 269 captures images that are processed to identify obstacles or other objects (e.g., field boundaries, adverse field conditions) in the field to avoid during planting. In one example, target location for placement of a next seed is determined based on a location and/or characteristic of a prior seed ejected by seed system 202.

Machine position and speed detector 304 are configured to detect the geographic position of machine 200 using signals from position sensor(s) 266 and to determine the speed of machine 200 based on signals from speed sensor(s) 268.

Seed ejection control component 306 is configured to generate a motor operating parameter to control motor 218 to eject each seed based on the targets determined by component 302. In the illustrated example, component 306 identifies, for each individual seed in mechanism 216, a target ejection time 208 for releasing the seed from component 228, a target motor position 308 corresponding to target ejection time 308, and a target motor speed 310 corresponding to target ejection time 308.

Target ejection time 208 is determined based on the target location for the seed placement and the current machine position and machine speed. That is, the target ejection time 208 represents the time at which the next seed in mechanism 216 is to be released so that it is placed in the furrow at the target location.

In one example, determination of target ejection time 308 is compensated for a time delay between when the seed is released from seed transport mechanism 216 and the seed is deposited in the furrow by delivery endpoint component 228. Accordingly, an endpoint compensation component 314 generates an estimation of an amount of time that it will take the seed to pass from seed transport mechanism 216 (after release) through delivery endpoint component 228 and reach the furrow. This time delay can vary based on the distance to, and geometry of, component 228.

For sake of illustration, but not by limitation, assume that component 314 determines that it will take approximately one-half second for the seed to reach the furrow, once released from component 216. Here, target ejection time 308 is calculated so that the seed is released approximately one-half second before component 228 (e.g., seed boot) is at the target location (taking into account the current machine position and the machine speed).

Component 306 identifies target motor position 310 for releasing the seed at the target ejection time 308. Illustratively, the target motor position 310 represents an angular rotational position of the output shaft of motor 218 at which mechanism 216 will be at a position in which the given seed will be released from mechanism 216 toward component 228. In one example, target motor position 310 is calculated based on a predefined rotational range over which the output shaft of motor 218 must rotate to move the portion of mechanism 216 containing the seed from the sensor location to the release location.

Component 306 identifies target motor speed 312 based on a desired instantaneous speed of mechanism 216 when the seed is released. This speed determines the velocity of the seed (relative to the row unit) when the seed is released. In one example, the target motor speed 312 is determined based on the machine speed. For instance, target motor speed 312 is selected so that the speed of transport mechanism 216 (and thus the speed of the seed when it is released) matches the speed of machine 200 to discourage, if not prevent, the seed from rolling in the furrow.

Seed ejection system 242 also includes a seed diversion system 316. Seed diversion system 316 is configured to remove a non-qualified, as determined based on the terahertz-based sensor, seed from the seed queue and either eject the non-qualified seed onto the ground (i.e., not planting it in a furrow) or diverting it to a non-qualified seed container. Seed ejection system 316 is configured to receive one or more control signals from processing system 238 to remove the non-qualified seed. Further, when seed diversion system 316 is engaged, processor 238 is configured to cause seed ejection system 242 to speed up the seed ejection system to compensate for the diverted, non-qualified seed, preferably without having to slow the planting machine. In one example, seed diversion system 316 includes an actuator 155 (shown in FIG. 3A) on each row unit. Actuator 155 is configured to engage a seed in the seed queue to remove the seed from the seed queue. As noted above, the diverted seed may simply be discarded on the ground, or it may be transported to a container for diverted seeds.

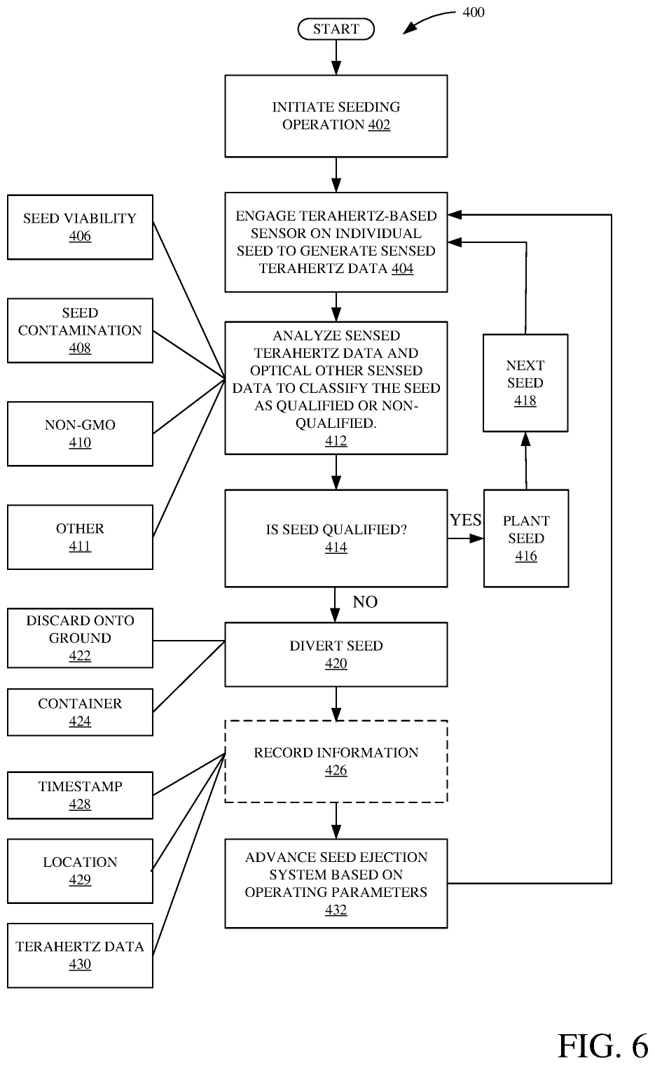

FIG. 6 is a flow diagram 400 illustrating an example operation of an agricultural machine. For sake of illustration, but not by limitation, FIG. 6 will be described in the context of agricultural machine 200 illustrated in FIG. 4. Method 400 begins at block 402 where a seeding operation of an agricultural machine is initiated. Next, at block 404, a terahertz-based sensor, such as sensor 222, is engaged to direct terahertz signals or electromagnetic radiation at an individual seed within the planter. One or more responses to the terahertz radiation interacting with the individual seed are detected as terahertz data. The one or more responses can include detecting attenuation of the signal after passing at least partially through the seed and/or detecting reflection of the signal from the seed.

At block 412, the sensed terahertz data is analyzed, such as by processing system 238 or any other suitable analysis device, to classify the seed as qualified or non-qualified. Such analysis may employ an artificial intelligence engine, such as AI engine 239, described above. The analysis can include detected characteristics of the seed such as seed viability 406, seed contamination 408, Non-GMO 410, or other relevant characteristics 411 that are detectable with terahertz signals using sensor 222. Next, at block 414, method 400 determines whether the seed is qualified for planting. If so, the seed is planting by allowing it to continue its path in the seed queue to be ultimately planted by the planter, as indicated at block 416. When this occurs, method 400 iterates to the next seed in the seed queue as indicated at block 418 and control returns to block 404.

If, at block 414, the seed is not viable, then control passes to block 420 where the seed is diverted from the seed queue. Once diverted, the seed may simply be discarded onto the ground, as indicated at block 422 or it may be transported to a storage container for non-qualified seeds, as indicated at block 424. In some examples, discarding seed on the ground may further comprise treating the seed with mechanical force (e.g., crushing or scoring), chemicals, radiation or other destructive techniques. In some examples, optional block 426 is executed during method 400 to record information about the discarded, non-qualified seed. Examples of such information include, without limitation, a timestamp 428 indicative of the time of the detection and/or sensor values, a location where the non-qualified seed was discarded, and/or seed classification information 430 indicative of the terahertz data that gave rise to the determination of non-qualification for the diverted seed. The information may be recorded locally in the agricultural machine 200, such as by storing it in data store 274 (shown in FIG. 4) or remotely using network 252 (shown in FIG. 4). When stored remotely, in one example, the information is recorded in a distributed immutable ledger (e.g., implemented as blockchain).

At block 432, method 400 compensates the sed queue for the diverted seed by advancing the seed ejection system to more quickly move the next seed into position of the terahertz-based sensor 222 in such that the new seed can be evaluated and discarded or planted in the intended position (or a very close approximation thereof) of the previously diverted non-qualified seed. Once the advance is completed, control returns to block 404.

Method 400 is performed for each row unit in the planter and continues until the planting operation is complete or otherwise ended by the operator.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors, processing systems, controllers and/or servers. In one example, these can include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

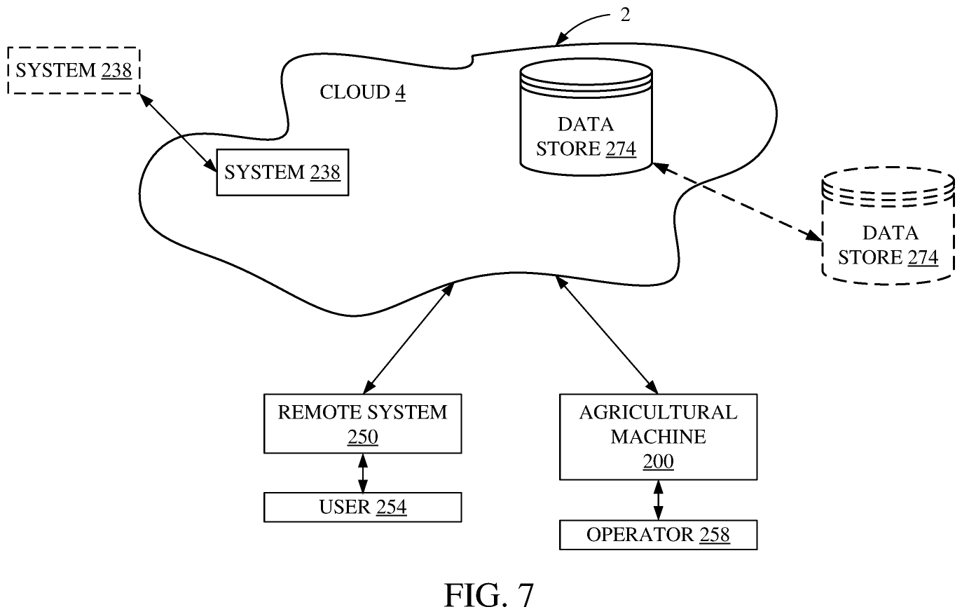

FIG. 7 is a block diagram of one example of the agricultural machine architecture, shown in FIG. 4, where agricultural machine 200 communicates with elements in a remote server architecture 2. In an example, remote server architecture 2 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and they can be accessed through a web browser or any other computing component. Software or components shown in FIG. 4 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided from a conventional server, or they can be installed on client devices directly, or in other ways. Remote server architecture 2 may host cloud storage, such as a portion of data store 274 that can store the immutable ledger containing information about non-qualified seeds being diverted from the planting operation. Further, all or a portion of AI engine 239 may be hosted by remote server architecture 2 such that the terahertz data is transmitted to the cloud-based AI engine for classification of each seed.

In the example shown in FIG. 7, some items are similar to those shown in FIG. 4 and they are similarly numbered. FIG. 7 specifically shows that system 238 and data store 274 can be located at a remote server location 4. Therefore, agricultural machine 200 accesses those systems through remote server location 4.

FIG. 7 also depicts another example of a remote server architecture. FIG. 7 shows that it is also contemplated that some elements of FIG. 4 are disposed at remote server location while others are not. By way of example, data store 274 can be disposed at a location separate from location 4, and accessed through the remote server at location 4. Alternatively, or in addition, system 238 can be disposed at location(s) separate from location 4, and accessed through the remote server at location 4.

Regardless of where they are located, they can be accessed directly by agricultural machine 200, through a network (either a wide area network or a local area network), they can be hosted at a remote site by a service, or they can be provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers. In such an example, where cell coverage is poor or nonexistent, another mobile machine (such as a fuel truck) can have an automated information collection system. As the agricultural machine comes close to a fuel truck for fueling, the system automatically collects the information from the machine or transfers information to the machine using any type of ad-hoc wireless connection. The collected information can then be forwarded to the main network as the fuel truck reaches a location where there is cellular coverage (or other wireless coverage). For instance, the fuel truck may enter a covered location when traveling to fuel other machines or when at a main fuel storage location. All of these architectures are contemplated herein. Further, the information can be stored on the agricultural machine until the agricultural machine enters a covered location. The agricultural machine, itself, can then send and receive the information to/from the main network.

It will also be noted that the elements of FIG. 4, or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

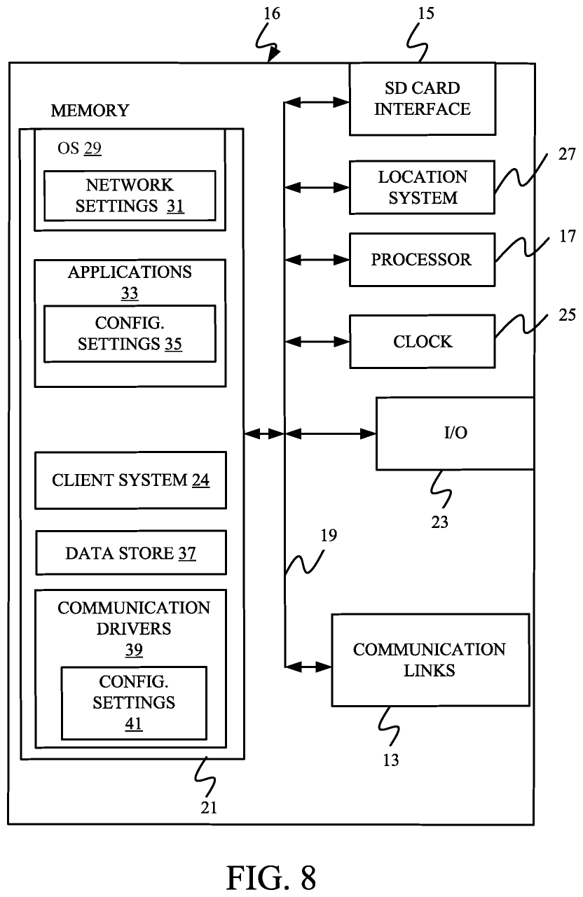

FIG. 8 is a simplified block diagram of one illustrative example of a handheld or mobile computing device that can be used as a user's or client's hand held device 16, in which the present system (or parts of it) can be deployed. For instance, a mobile device can be deployed in the operator compartment of agricultural machine 200 or as remote system 250.

FIG. 8 provides a general block diagram of the components of a client device 16 that can run some components shown in FIG. 4, that interacts with them, or both. In the device 16, a communications link 13 is provided that allows the handheld device to communicate with other computing devices and under some embodiments provides a channel for receiving information automatically, such as by scanning Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various embodiments of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

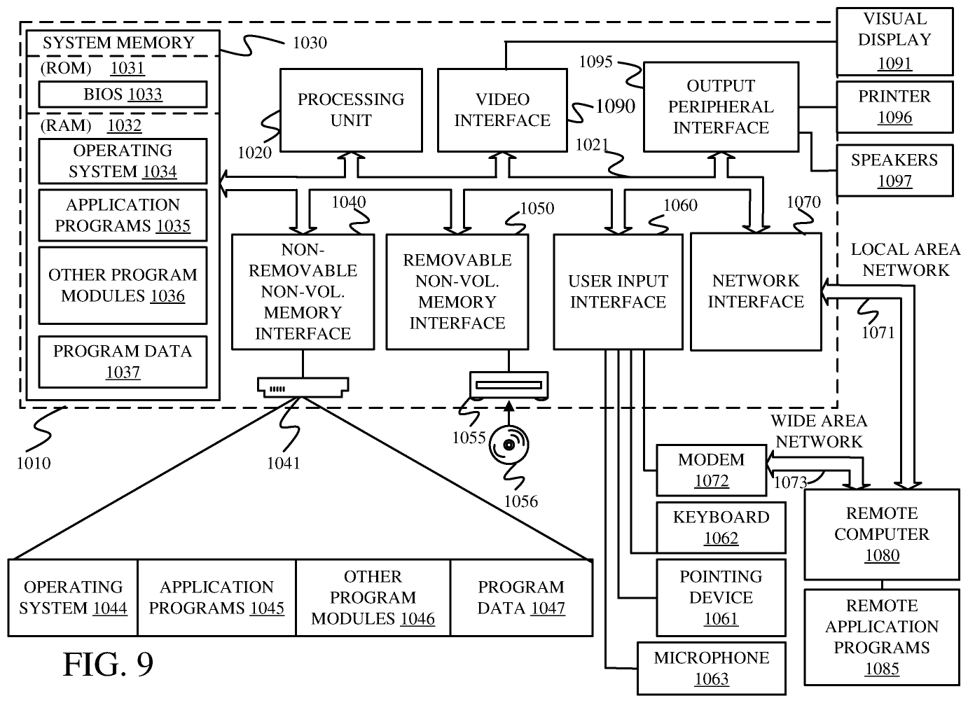

FIG. 9 is one example of a computing environment in which elements of FIG. 4, or parts of it, (for example) can be deployed. With reference to FIG. 9, an example system for implementing some embodiments includes a computing device in the form of a computer 1010. Components of computer 1010 may include, but are not limited to, a processing unit 1020 (which can comprise processors or servers from previous FIGS.), a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. Memory and programs described with respect to FIG. 4 can be deployed in corresponding portions of FIG. 9.

Computer 1010 typically includes a variety of computer readable media. Computer readable media can be any available media that can be accessed by computer 1010 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1010. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1030 includes computer storage media in the form of volatile and/or nonvolatile memory such as read only memory (ROM) 1031 and random access memory (RAM) 1032. A basic input/output system 1033 (BIOS), containing the basic routines that help to transfer information between elements within computer 1010, such as during start-up, is typically stored in ROM 1031. RAM 1032 typically contains data and/or program modules that are immediately accessible to and/or presently being operated on by processing unit 1020. By way of example, and not limitation, FIG. 9 illustrates operating system 1034, application programs 1035, other program modules 1036, and program data 1037.

The computer 1010 may also include other removable/non-removable volatile/nonvolatile computer storage media. By way of example only, FIG. 9 illustrates a hard disk drive 1041 that reads from or writes to non-removable, nonvolatile magnetic media, an optical disk drive 1055, and nonvolatile optical disk 1056. The hard disk drive 1041 is typically connected to the system bus 1021 through a non-removable memory interface such as interface 1040, and optical disk drive 1055 is typically connected to the system bus 1021 by a removable memory interface, such as interface 1050.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 1010. In FIG. 9, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037.

A user may enter commands and information into the computer 1010 through input devices such as a keyboard 1062, a microphone 1063, and a pointing device 1061, such as a mouse, trackball or touch pad. Other input devices (not shown) may include a joystick, game pad, satellite dish, scanner, or the like. These and other input devices are often connected to the processing unit 1020 through a user input interface 1060 that is coupled to the system bus, but may be connected by other interface and bus structures. A visual display 1091 or other type of display device is also connected to the system bus 1021 via an interface, such as a video interface 1090. In addition to the monitor, computers may also include other peripheral output devices such as speakers 1097 and printer 1096, which may be connected through an output peripheral interface 1095.

The computer 1010 is operated in a networked environment using logical connections (such as a local area network—LAN, or wide area network—WAN or a controller area network—CAN) to one or more remote computers, such as a remote computer 1080.

When used in a LAN networking environment, the computer 1010 is connected to the LAN 1071 through a network interface or adapter 1070. When used in a WAN networking environment, the computer 1010 typically includes a modem 1072 or other means for establishing communications over the WAN 1073, such as the Internet. In a networked environment, program modules may be stored in a remote memory storage device. FIG. 9 illustrates, for example, that remote application programs 1085 can reside on remote computer 1080.

It should also be noted that the different examples described herein can be combined in different ways. That is, parts of one or more examples can be combined with parts of one or more other examples. All of this is contemplated herein.

Example 1 is an agricultural machine includes a seeding system having a seed transport mechanism configured to transport a seed. A terahertz-based seed sensor is configured to direct terahertz electromagnetic radiation toward the seed at a sensing location and detect terahertz electromagnetic radiation after the terahertz electromagnetic radiation interacts with the seed to provide terahertz data. An actuator is configured to selectively move the seed. A processing system is configured to receive the terahertz data and classify the seed as qualified or non-qualified and to selectively engage the actuator based on whether the seed is classified as qualified or non-qualified.

Example 2 is the agricultural machine of any or all of the previous examples, wherein the actuator is configured to divert the seed.

Example 3 is the agricultural machine of any or all of the previous examples, wherein the processing system is configured to employ an artificial intelligence engine to relate the signal from the terahertz-based seed sensor to at least one detected parameter.

Example 4 is the agricultural machine of any or all of the previous examples, wherein the processing system is configured to classify the seed based on the whether the seed is viable.

Example 5 is the agricultural machine of any or all of the previous examples, wherein the processing system is configured to classify the seed based on whether the seed is contaminated.

Example 6 is the agricultural machine of any or all of the previous examples, wherein the contamination is chemical contamination.

Example 7 is the agricultural machine of any or all of the previous examples, wherein the contamination is biological contamination.

Example 8 is the agricultural machine of any or all of the previous examples, wherein the contamination is non-GMO contamination.

Example 9 is the agricultural machine of any or all of the previous examples, wherein the processing system is configured to cause a seed ejection system to eject a non-qualified seed onto the ground.

Example 10 is the agricultural machine of any or all of the previous examples, wherein the processing system is configured to cause a seed ejection system to transport a non-qualified seed to a non-qualified seed container.

Example 11 is the agricultural machine of any or all of the previous examples, wherein the terahertz-based seed sensor detector is disposed to detect terahertz electromagnetic radiation reflected from the seed.

Example 12 is the agricultural machine of any or all of the previous examples, wherein the terahertz-based seed sensor detector is disposed to detect terahertz electromagnetic radiation passing through the seed.

Example 13 is the agricultural machine of any or all of the previous examples, wherein the processing system is configured to store information related to detection of a non-qualified seed.

Example 14 is the agricultural machine of any or all of the previous examples, wherein the information includes a location.

Example 15 is the agricultural machine of any or all of the previous examples, wherein the information includes terahertz data associated with the non-qualified seed.

Example 16 is a system for planting seeds. The system includes a seed meter comprising a rotor with slots that are spaced apart from each other, each slot having a suitable shape and size to receive a corresponding seed, the seed meter having an entrance port for receiving seed into the seed meter and an exit port for seed exiting the seed meter, where each exiting seed is spaced spatially from any prior seed or later seed exiting the exit port. A conveyor includes a retaining member for receive the seed from the exit port, the conveyor conveying seed exiting the seed meter to a seed discharge port for depositing or planting the seed in a furrow in the ground. The system also includes a seed detection area through which seeds pass and a source of terahertz-based electromagnetic radiation disposed to direct terahertz electromagnetic radiation into the seed detection area. At least one detector is disposed to detect the terahertz electromagnetic radiation after interacting with a seed in the seed detection area. A processing system is coupled to the at least one detector and configured to classify the seed as qualified or non-qualified based on a signal from the at least one detector. An actuator is configured to selectively divert the seed based on a signal from the processing system.

Example 17 is the system of any or all of the previous examples, wherein the source is selected from the group consisting of a femtosecond Ti-sapphire laser, a Yttrium Iron Garnet (YIG)-oscillator, a quantum cascade laser, a P-type germanium laser, a silicon-based laser, a free electron laser, a photoconductive switch, optical rectification, a backward-wave oscillator, a transferred electron device, and a resonant tunneling diode.

Example 18 is the system of any or all of the previous examples, wherein the at least one detector is selected from the group consisting of a photoconductive semiconductor, free-space electro-optic sampling using ZnTe and BBO crystals, bolometer, an interferometer, Schottkey diode, backward diode, High-Electron-Mobility-Transistor (HEMT), Golay cell, and a pyroelectric detector.

Example 19 is the system of any or all of the previous examples, wherein the seed detection area is located within the seed meter.

Example 20 is a method of planting seeds. The method includes initiating an agricultural planting operation and directing terahertz electromagnetic radiation at a single seed in a seed queue of an agricultural planter and receiving the terahertz electromagnetic radiation after interacting with the single seed using at least one detector. A signal is received from the at least one detector and classifying the seed based on the received signal. The seed is selectively planted based on whether the seed is classified as qualified.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, while specific examples are described with respect to detecting seeds along a seed transport route, it is expressly contemplated that embodiments can be practiced where the terahertz sensor is located within or on a seed meter such that seeds are detected on the seed meter and only provided from the seed meter to the seed transport route based on viability detection from the terahertz sensor. If a seed in the seed meter is not determined to be viable, it is released to a diversion route where it may be collected and stored, discarded onto the ground after suitable destruction (e.g., crushed, heated, chemically treated, radiologically treated, or other suitable destruction).

What is claimed is:

1. An agricultural machine comprising:
a seeding system comprising:
a seed transport mechanism configured to transport a seed;
a terahertz-based seed sensor configured to direct terahertz electromagnetic radiation toward the seed at a sensing location and detect terahertz electromagnetic radiation after the terahertz electromagnetic radiation interacts with the seed to provide terahertz data; and
an actuator configured to selectively move the seed;
a processing system configured to:
receive the terahertz data and classify the seed as qualified or non-qualified and to selectively engage the actuator based on whether the seed is classified as qualified or non-qualified.

2. The agricultural machine of claim 1, wherein the actuator is configured to divert the seed.

3. The agricultural machine of claim 1, wherein the processing system is configured to employ an artificial intelligence engine to relate the signal from the terahertz-based seed sensor to at least one detected parameter.

4. The agricultural machine of claim 1, wherein the processing system is configured to classify the seed based on the whether the seed is viable.

5. The agricultural machine of claim 1, wherein the processing system is configured to classify the seed based on whether the seed is contaminated.

6. The agricultural machine of claim 5, wherein the contamination is chemical contamination.

7. The agricultural machine of claim 5, wherein the contamination is biological contamination.

8. The agricultural machine of claim 5, wherein the contamination is non-GMO contamination.

9. The agricultural machine of claim 1, and wherein the processing system is configured to cause a seed ejection system to eject a non-qualified seed onto the ground.

10. The agricultural machine of claim 1, wherein the processing system is configured to cause a seed ejection system to transport a non-qualified seed to a non-qualified seed container.

11. The agricultural machine of claim 1, wherein the terahertz-based seed sensor detector is disposed to detect terahertz electromagnetic radiation reflected from the seed.

12. The agricultural machine of claim 1, wherein the terahertz-based seed sensor detector is disposed to detect terahertz electromagnetic radiation passing through the seed.

13. The agricultural machine of claim 1, wherein the processing system is configured to store information related to detection of a non-qualified seed.

14. The agricultural machine of claim 13, wherein the information includes a location.

15. The agricultural machine of claim 13, wherein the information includes terahertz data associated with the non-qualified seed.

16. A system for planting seeds, the system comprising:
a seed meter comprising a rotor with slots that are spaced apart from each other, each slot having a suitable shape and size to receive a corresponding seed, the seed meter having an entrance port for receiving seed into the seed meter and an exit port for seed exiting the seed meter, where each exiting seed is spaced spatially from any prior seed or later seed exiting the exit port;
a conveyor comprising a retaining member for receive the seed from the exit port, the conveyor conveying seed exiting the seed meter to a seed discharge port for depositing or planting the seed in a furrow in the ground;
a seed detection area through which seeds pass;
a source of terahertz-based electromagnetic radiation disposed to direct terahertz electromagnetic radiation into the seed detection area;
at least one detector disposed to detect the terahertz electromagnetic radiation after interacting with a seed in the seed detection area;
a processing system coupled to the at least one detector and configured to classify the seed as qualified or non-qualified based on a signal from the at least one detector; and
an actuator configured to selectively divert the seed based on a signal from the processing system.

17. The system of claim 16, wherein the source is selected from the group consisting of a femtosecond Ti-sapphire laser, a Yttrium Iron Garnet (YIG)-oscillator, a quantum cascade laser, a P-type germanium laser, a silicon-based laser, a free electron laser, a photoconductive switch, optical rectification, a backward-wave oscillator, a transferred electron device, and a resonant tunneling diode.

18. The system of claim 16, wherein the at least one detector is selected from the group consisting of a photoconductive semiconductor, free-space electro-optic sampling using ZnTe and BBO crystals, bolometer, an interferometer, Schottkey diode, backward diode, High-Electron-Mobility-Transistor (HEMT), Golay cell, and a pyroelectric detector.

19. The system of claim 16, wherein the seed detection area is located within the seed meter.

20. A method of planting seeds, the method comprising:
initiating an agricultural planting operation;
directing terahertz electromagnetic radiation at a single seed in a seed queue of an agricultural planter and receiving the terahertz electromagnetic radiation after interacting with the single seed using at least one detector;
receiving a signal from the at least one detector and classifying the seed based on the received signal; and
selectively causing the seed to be planted based on whether the seed is classified as qualified.
